(19) United States
(12) Patent Application Publication
(10) Pub. No.: US 2022/0083597 A1
(43) Pub. Date: Mar. 17, 2022

(54) AUTONOMOUS METHOD, SYSTEM AND SOFTWARE APPARATUS FOR PERFORMING DATA-WRANGLING TASKS THROUGH THE USE OF VOICE OR TEXT-BASED COMMANDS

(71) Applicant: Peter Atore, New York, NY (US)

(72) Inventor: Peter Atore, New York, NY (US)

(21) Appl. No.: 17/020,806

(22) Filed: Sep. 15, 2020

(51) Int. Cl. G06F 16/906; G06F 16/9032; G06F 16/901; G06F 3/16

(52) U.S. Cl. CPC G06F 16/906; G06F 3/167; G06F 16/901; G06F 16/90332

(57) ABSTRACT

Methods and systems for data wrangling involve issuing a data-wrangling command with respect to a raw data source comprising unstructured data, in response to an input by a user; translating the data-wrangling command into an executable data wrangling task with respect to the raw data source; and autonomously performing the executable data wrangling task with respect to the raw data source after translating the data-wrangling command into the executable data wrangling task.

### TECHNICAL FIELD

Embodiments are related to the field of data processing. Embodiments further relate to the field of data wrangling. Embodiments also relate to methods and systems that can interact with web-based or downloadable software through voice and text commands that can be then processed into automated data wrangling tasks to be performed with respect to different file formats and data sources.

### BACKGROUND

Data wrangling, sometimes also referred as ‘data munging’, can be described as a process of transforming and mapping data from one ‘raw’ data form into another format with the intent of making it more appropriate and valuable for a variety of downstream purposes such as analytics.

A data wrangler can be a person who performs these transformation operations, typically in manual operations. Current approaches to data wrangling involve enlisting groups of data analysts and data scientists manually performing data wrangling tasks. This manual process is very tedious, time consuming, prone to error and cost ineffective. What is needed to address this problem is the development and implementation of a faster, reliable, efficient and cost-effective approach to data wrangling.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide an improved methods and systems for data wrangling.

It is another aspect of the disclosed embodiments to provide methods and systems for automatically executing data-wrangling tasks from voice or text based commands that have been translated from a natural language processing engine.

It is a further aspect of the disclosed embodiments to provide voice or text command based assisted methods and systems that can be performed through a web-based or downloadable software apparatus that can translate the commands through a natural processing engine into executable data wrangling tasks, thereby eliminating the need for a human to manually perform data wrangling tasks.

The aforementioned aspects and other objectives and advantages can now be achieved as described herein. In an embodiment, a method for data wrangling, can involve: issuing a data-wrangling command with respect to a raw data source comprising unstructured data, in response to an input by a user; translating the data-wrangling command into an executable data wrangling task with respect to the raw data source; and autonomously performing the executable data wrangling task with respect to the raw data source after translating the data-wrangling command into the executable data wrangling task.

In an embodiment, the data-wrangling command can be translated into the executable data wrangling task by a natural language process engine accessible as at least one of: an application programming interface or a web service.

In an embodiment, the executable data wrangling task with respect to the raw data source can involve: gathering relevant unstructured data from the unstructured data in the raw data source from at least one of: a remote server, a computer file system associated with the user, an application programming interface, a web service, or a mobile device; and sending relevant processed unstructured data to at least one of: the remote server, the computer file system associated with the user, the application programming interface, the web service, or the mobile device.

In an embodiment, the data-wrangling command can comprise one or more of: a voice command and a text command.

In an embodiment, the voice command or the text command can comprise a data-wrangling command involving at least one of the following types of data-wrangling commands: a command to merge file records with respect to the unstructured data, a command to perform qualitative data categorization with respect to the unstructured data, a command to perform quantitative data categorization with respect to the unstructured data, a command to perform mathematical functions with respect to the unstructured data, a command to perform data sorting with respect to the unstructured data, a command to perform data grouping with respect to the unstructured data, a command to send processed data to a specified location after execution of a data wrangling task, a command to perform data comparison with respect to the unstructured data, and/or command to perform data formatting with respect to the unstructured data.

In an embodiment, the executable data wrangling task can comprise an Extract Transform and Load (ETL) functionality executed autonomously.

In an embodiment, the executable data wrangling task can comprise a process of transforming and mapping data from one form into another to render the data more appropriate and valuable for a plurality of downstream purposes than the unstructured data.

In another embodiment, a system for data wrangling, can comprise at least one processor, and a non-transitory computer-usable medium embodying computer program code, the computer-usable medium operable to communicate with the at least one processor. The computer program code can comprise instructions executable by the at least one processor and configured for: issuing a data-wrangling command with respect to a raw data source comprising unstructured data, in response to an input by a user; translating the data-wrangling command into an executable data wrangling task with respect to the raw data source; and autonomously performing the executable data wrangling task with respect to the raw data source after translating the data-wrangling command into the executable data wrangling task.

In an embodiment of the system, the data-wrangling command can be translated into the executable data wrangling task by a natural language process engine accessible as at least one of: an application programming interface or a web service.

In an embodiment of the system, the instructions for translating the data-wrangling command into the executable data wrangling task with respect to the raw data source, can further comprise instructions configured for: gathering relevant unstructured data from the unstructured data in the raw data source from at least one of: a remote server, a computer file system associated with the user, an application programming interface, a web service, or a mobile device; and sending relevant processed unstructured data to at least one of: the remote server, the computer file system associated with the user, the application programming interface, the web service, or the mobile device.

In an embodiment of the system, the data-wrangling command can comprise at least one of: a voice command or a text command.

In an embodiment of the system, the voice command or the text command can comprise a data-wrangling command involving at least one of the following types of data-wrangling commands: a command to merge file records with respect to the unstructured data, a command to perform qualitative data categorization with respect to the unstructured data, a command to perform quantitative data categorization with respect to the unstructured data, a command to perform mathematical functions with respect to the unstructured data, a command to perform data sorting with respect to the unstructured data; a command to perform data grouping with respect to the unstructured data, a command to send processed data to a specified location after execution of a data wrangling task, a command to perform data comparison with respect to the unstructured data, and/or a command to perform data formatting with respect to the unstructured data.

In an embodiment of the system, the executable data wrangling task can comprise an Extract Transform and Load (ETL) functionality executed autonomously.

In an embodiment of the system, the executable data wrangling task can comprise a process of transforming and mapping data from one form into another to render the data more appropriate and valuable for a plurality of downstream purposes than the unstructured data.

In an embodiment, a non-transitory computer-readable media can include instructions which when executed by the one or more processors, cause the one or more processors to perform data wrangling operations including: issuing a data-wrangling command with respect to a raw data source comprising unstructured data, in response to an input by a user; translating the data-wrangling command into an executable data wrangling task with respect to the raw data source; and autonomously performing the executable data wrangling task with respect to the raw data source after translating the data-wrangling command into the executable data wrangling task.

In an embodiment of the non-transitory computer-readable media, the data-wrangling command can be translated into the executable data wrangling task by a natural language process engine accessible as at least one of: an application programming interface or a web service.

In an embodiment of the non-transitory computer-readable media, the executable data wrangling task with respect to the raw data source can involve: gathering relevant unstructured data from the unstructured data in the raw data source from at least one of: a remote server, a computer file system associated with the user, an application programming interface, a web service, or a mobile device; and sending relevant processed unstructured data to at least one of: the remote server, the computer file system associated with the user, the application programming interface, the web service, or the mobile device.

In an embodiment of the non-transitory computer-readable media, the data-wrangling command can comprise at least one of: a voice command and a text command.

In an embodiment of the non-transitory computer-readable media, the voice command or the text command can comprise a data-wrangling command involving at least one of the following types of data-wrangling commands: a command to merge file records with respect to the unstructured data, a command to perform qualitative data categorization with respect to the unstructured data, a command to perform quantitative data categorization with respect to the unstructured data, a command to perform mathematical functions with respect to the unstructured data, a command to perform data sorting with respect to the unstructured data, a command to perform data grouping with respect to the unstructured data, a command to send processed data to a specified location after execution of a data wrangling task, a command to perform data comparison with respect to the unstructured data, and/or a command to perform data formatting with respect to the unstructured data.

In an embodiment of the non-transitory computer-readable media, the executable data wrangling task can comprise an Extract Transform and Load (ETL) functionality executed autonomously.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a flow chart of operations depicting logical operational steps of a method for data wrangling, in accordance with an embodiment;

FIG. 2 illustrates a block diagram depicting a system for data wrangling, in accordance with an embodiment;

FIG. 3 illustrates a flow chart of operations depicting logical operational steps of a method for data wrangling, in accordance with an alternative embodiment;

FIG. 4 illustrates a schematic view of a computer system, in accordance with an embodiment; and

FIG. 5 illustrates a schematic view of a software apparatus including a module, an operating system, and a user interface, in accordance with an embodiment.

### DETAILED DESCRIPTION

The particular values and configurations discussed in these non-limiting examples can be varied and are cited merely to illustrate one or more embodiments and are not intended to limit the scope thereof.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The following detailed description is, therefore, not intended to be interpreted in a limiting sense.

Throughout the specification and claims, terms may have nuanced meanings suggested or implied in context beyond an explicitly stated meaning. Likewise, phrases such as “in one embodiment” or “in an example embodiment” and variations thereof as utilized herein do not necessarily refer to the same embodiment and the phrase “in another embodiment” or “in another example embodiment” and variations thereof as utilized herein may or may not necessarily refer to a different embodiment. It is intended, for example, that claimed subject matter include combinations of example embodiments in whole or in part.

In general, terminology may be understood, at least in part, from usage in context. For example, terms such as “and,” “or,” or “and/or” as used herein may include a variety of meanings that may depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms such as “a,” “an,” or “the”, again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Several aspects of data-processing systems will now be presented with reference to various systems and methods. These systems and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. A mobile “app” is an example of such software.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer.

By way of example, and not limitation, such computer-readable media can include read-only memory (ROM) or random-access memory (RAM), electrically erasable programmable ROM (EEPROM), including ROM implemented using a compact disc (CD) or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, digital versatile disc (DVD), and floppy disk where disks usually reproduce data magnetically, while discs reproduce data optically with lasers. Combinations of the above should also be included within the scope of computer-readable media.

The term ‘data wrangling’ as used herein can relate to a process of transforming and mapping data from one form into another with the intent of making the data more appropriate and valuable for a variety of downstream purposes such as analysis.

The term ‘data wrangling tasks’ as used herein can include merging file records, qualitative data categorization, quantitative data categorization, executing mathematical functions (e.g. weighted average analysis, data summation, data sorting, data grouping, and data formatting).

The acronym API as used herein refers to ‘Application Programming Interface’ and can relate to a computing interface that can define interactions between multiple software intermediaries.

The term ‘Extensible Markup Language’ as used herein can relate to markup language that can define a set of rules for encoding documents in a format that is both human readable and machine readable.

The term ‘Comma Separated Value File’ as used herein can relate to a delimited text file that uses a comma to separate values.

The term ‘JavaScript Object Notation’ as used herein can relate to an open standard file format, and data interchange format that can use human-readable text to store and transmit data objects comprising attribute-value pairs and array data objects.

The acronym FTP as used herein refers ‘File Transfer Protocol’ (FTP) and relates to a standard network protocol that can be used for the transfer of computer files between a client and server on a computer network.

The disclosed embodiments relate to methods and systems that can interact with a web-based apparatus or a downloadable software apparatus (also referred to as a ‘software apparatus’) through voice and text commands that can be then processed by a natural language processing engine to be translated into automated data wrangling tasks to be performed on different file formats and data sources.

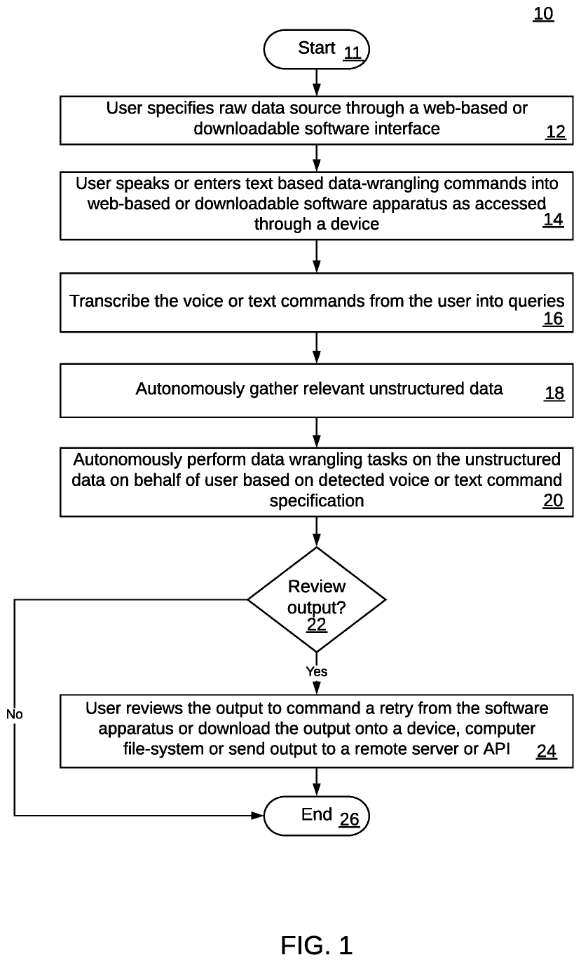

FIG. 1 illustrates a flow chart of operations depicting logical operational steps of a method 10 for data wrangling, in accordance with an embodiment. As indicated at block 11, the process can begin. Next, as shown at block 12, a step or operation can be implemented in which an end-user can specify a raw data source through a web-based or downloadable software interface. Thereafter, as depicted at block 14, a step or operation can be implemented in which the end-user can speak or enter text based data-wrangling commands into the web-based or downloadable software apparatus as accessed through a device.

An example of a command may be “I want to merge all files delivered today into file X with the email field serving as the unique identifier”. Another example of a command may be “I want to see the weighted average of the X data”. Still, another example of a command may be “I want to see the sum of the data in column X”.

Note that the term ‘device’ as utilized herein may refer to a computing device, which may be, for example, a desktop computer, a mobile computing device such as a smartphone or tablet computing device, a wearable computing device, a laptop computer, and so on.

Following processing of the step or operation depicted at block 14, a step or operation can be implemented as shown at block 16 in which the software apparatus natively or through a web-service, transcribes the voice or text commands from the user into queries that are in turn understood by the software apparatus.

Thereafter, as depicted at block 18, a step or operation can be implemented in which the software apparatus autonomously gathers relevant unstructured data from either a remote server, an end-user's computer file system, web-service or mobile device. The software apparatus can then autonomously perform data wrangling tasks on the unstructured data as illustrated at block 20 on behalf of the end-user based on the detected voice or text command specification.

Next, as depicted at decision block 22 and at block 24, the end-user can then opt to review the output to command a retry from the software apparatus or download the output onto a device, computer file-system or send the output to a remote server or API. The process can then terminate, as shown at block 26.

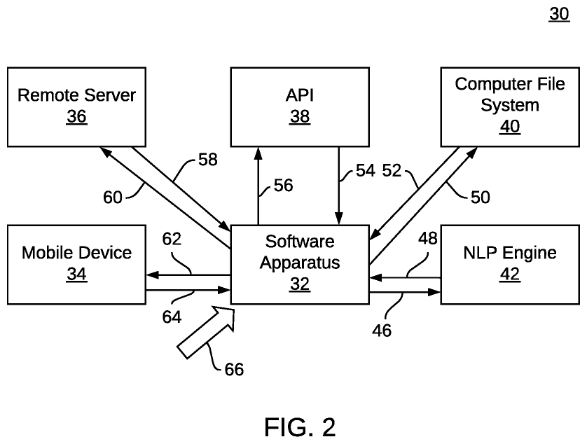

FIG. 2 illustrates a block diagram depicting a system 30 for data wrangling, in accordance with an embodiment. The system 30 depicted in FIG. 2 includes a software apparatus 32 that can be configured to send a text command or a voice command to a natural language processing engine 42 as indicated by arrow 46. The natural language processing engine 42 can send back the translated machine readable data wrangling task instructions to be executed by the software apparatus 32 as indicated by arrow 48. The natural language processing engine 42 can be configured to translate voice and text commands to data wrangling tasks.

The end user can send a voice-based command or can enter a test-based command into the software apparatus 32 accessed through a device as indicated by arrow 66. The user can utilize a device such as mobile device 34 with the software apparatus 32 that allows the user to interact with through the aforementioned voice or text commands. The software apparatus 32 can be configured as a web-based or downloadable software apparatus that performs the autonomous data wrangling tasks as accessed through, for example, the mobile device 34.

As indicated at arrow 50, the software apparatus 32 can send a request for unstructured data to a computer file system 40. Arrow 52 shown in FIG. 2 depicts the unstructured data files being sent to the software apparatus 32 from an end-user's computer file system 40. The data wrangling system 30 can further include an API 38.

Arrow 54 shown in FIG. 2 represents a request to the AIP 38 for unstructured data files from the software apparatus 32. Arrow 56 depicted in FIG. 2 indicates a response with unstructured data files from the API 38. Arrow 58 indicates a response from a remote server 36 with unstructured data files to the software apparatus 32.

A request to the remote server 36 or database for data files from the software apparatus 32 is indicated by arrow 60. Arrow 62 indicates a request from the software apparatus 32 to the mobile device 34 for unstructured data files. Arrow 64 indicates a response with unstructured data files from the mobile device 34 to the software apparatus 32.

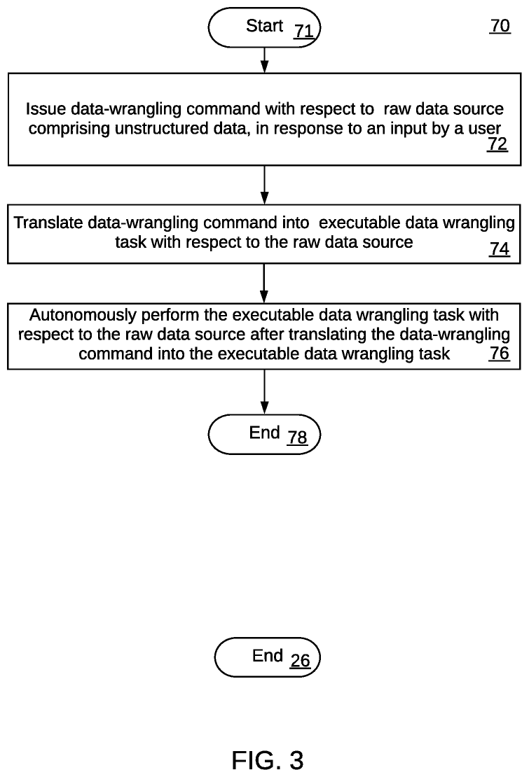

FIG. 3 illustrates a flow chart of operations depicting logical operational steps of a method 70 for data wrangling, in accordance with an alternative embodiment. As it indicated at block 71, the process can begin. Thereafter, as shown at block 72, a step or operation can be implemented to issue a data-wrangling command with respect to a raw data source comprising unstructured data, in response to an input by a user. Next, as depicted at block 74, a step or operation can be implemented to translate the data-wrangling command into an executable data wrangling task with respect to the raw data source. Then, as shown at block 76, a step or operation can be implemented to autonomously perform the executable data wrangling task with respect to the raw data source after translating the data-wrangling command into the executable data wrangling task.

Note that the data-wrangling command can be translated into the executable data wrangling task by a natural language process engine (e.g., NLP engine 42 shown in FIG. 2) accessible as at least one of: an application programming interface or a web service.

The executable data wrangling task with respect to the raw data source can involve steps or operations including gathering relevant unstructured data from the unstructured data in the raw data source from at least one of: a remote server, a computer file system associated with the user, an application programming interface, a web service, or a mobile device; and sending relevant processed unstructured data to at least one of: the remote server, the computer file system associated with the user, the application programming interface, the web service, or the mobile device. The data-wrangling command can comprise at least one of: a voice command or a text command.

The voice command or the text command can comprise a data-wrangling command involving one or more of the following types of data-wrangling commands: a command to merge file records with respect to the unstructured data; a command to perform qualitative data categorization with respect to the unstructured data; a command to perform quantitative data categorization with respect to the unstructured data; a command to perform mathematical functions with respect to the unstructured data; a command to perform data sorting with respect to the unstructured data; a command to perform data grouping with respect to the unstructured data; a command to send processed data to a specified location after execution of a data wrangling task; a command to perform data comparison with respect to the unstructured data; and/or a command to perform data formatting with respect to the unstructured data.

The executable data wrangling task can comprise an Extract Transform and Load (ETL) functionality executed autonomously. The executable data wrangling task can comprise a process of transforming and mapping data from one form into another to render the data more appropriate and valuable for a plurality of downstream purposes than the unstructured data.

It can be appreciated that the disclosed embodiments can involve automatically executing data-wrangling tasks from voice or text based commands that have been translated from a natural language processing engine. The forms of data-wrangling tasks performed can include, for example, merging file records, qualitative data categorization, quantitative data categorization, and executing mathematical functions (e.g., weighted average analysis, data summation, data sorting, data grouping, and data formatting).

The embodiments can include voice or text command based assisted methods and systems performed through a web-based or downloadable software apparatus that translates the commands through a natural processing engine into executable data wrangling tasks thereby eliminating the need for a human to manually perform data wrangling tasks.

The disclosed methods and software apparatus can perform data wrangling tasks on JavaScript Object Notation (JSON) format files, Extensible Markup Language (XML) files, Image Files, Comma Separated Value (CSV) Files, Excel Files and Structured Queried Language (SQL) data Files. These files may exist on an end-user's computer file-system or a remote server. The outputs from the data-wrangling tasks may be stored on the web-based or downloadable software apparatus, on a computer file system, a database, or on a remote server via an FTP or API. The disclosed approach can also be used to execute ETL functionality autonomously through voice or text command interaction rather than manual methods of ETL.

The embodied methods and systems are dissimilar from personal assistants (e.g. Alexa, Google Voice, SIRI, Cortana and Samsung Viv) in that the disclosed approach focuses on translation of commands to be used for executing data wrangling tasks within a software apparatus and not to act as a personal assistant. The embodied method does not perform verbal interaction specifically. That is, it does not talk to users or engage in verbal communication as a personal assistant would.

The disclosed embodiments are described at least in part herein with reference to the flowchart illustrations, steps and/or block diagrams of methods, systems, and computer program products and data structures and scripts. It will be understood that each block of the illustrations, and combinations of blocks, can be implemented by computer program instructions. These computer program instructions may be provided to a processor of, for example, a general-purpose computer, special-purpose computer, or other programmable data processing apparatus to produce a machine, such that the instructions, which can execute via the processor of the computer or other programmable data processing apparatus, and may create means for implementing the functions/acts specified in the block or blocks.

To be clear, the disclosed embodiments may be implemented in the context of, for example a special-purpose computer or a general-purpose computer, or other programmable data processing apparatus or system. For example, in some example embodiments, a data processing apparatus or system can be implemented as a combination of a special-purpose computer and a general-purpose computer. In this regard, a system composed of different hardware and software modules and different types of data wrangling features may be considered a special-purpose computer designed with a purpose of enabling data wrangling or data munging applications such as discussed herein. In general, however, embodiments may be implemented as a method, and/or a computer program product at any possible technical detail level of integration. The computer program product may include a computer readable storage medium (or media) having computer readable program instructions thereon for causing a processor to carry out aspects of the embodiments, such as the steps, operations or instructions described herein.

The aforementioned computer program instructions may also be stored in a computer-readable memory that can direct a computer or other programmable data processing apparatus to function in a particular manner, such that the instructions (e.g., steps/operations) stored in the computer-readable memory produce an article of manufacture including instruction means which implement the function/act specified in the various block or blocks, flowcharts, and other architecture illustrated and described herein.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks herein.

The flow charts and block diagrams in the figure can illustrate the architecture, the functionality, and the operation of possible implementations of systems, methods, and computer program products according to various embodiments (e.g., preferred or alternative embodiments). In this regard, each block in the flow chart or block diagrams may represent a module, a segment, or a portion of instructions, which comprises one or more executable instructions for implementing the specified logical function(s).

In some alternative implementations, the functions noted in the blocks may occur out of the order noted in the figures. For example, two blocks shown in succession may, in fact, be executed concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The functionalities described herein may be implemented entirely and non-abstractly as physical hardware, entirely as physical non-abstract software (including firmware, resident software, micro-code, etc.) or combining non-abstract software and hardware implementations that may all generally be referred to herein as a “circuit,” “module,” “engine”, “component,” “block”, “database”, “agent” or “system.” Furthermore, aspects of the present disclosure may take the form of a computer program product embodied in one or more non-ephemeral computer readable media having computer readable and/or executable program code embodied thereon.

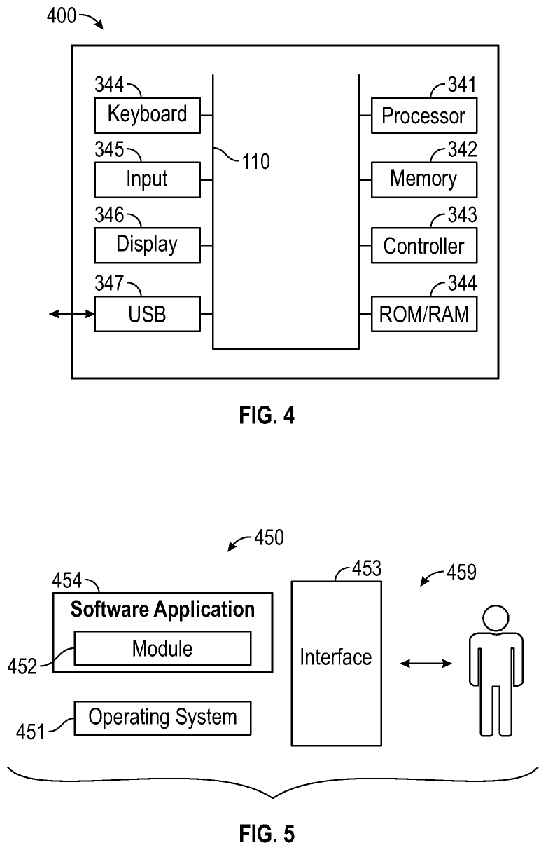

FIG. 4 and FIG. 5 are shown only as exemplary diagrams of data-processing environments in which example embodiments may be implemented. It should be appreciated that FIG. 4 and FIG. 5 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

As illustrated in FIG. 4, some embodiments may be implemented in the context of a data-processing system 400 that can include, for example, one or more processors such as a processor 341 (e.g., a CPU (Central Processing Unit) and/or other microprocessors), a memory 342, a controller 343, additional memory such as ROM/RAM 332 (i.e. ROM and/or RAM), a peripheral USB (Universal Serial Bus) connection 347, a keyboard 344 and/or another input device 345 (e.g., a pointing device, such as a mouse, track ball, pen device, etc.), a display 346 (e.g., a monitor, touch screen display, etc) and/or other peripheral connections and components. The database 114 illustrated and discussed previously herein may in some embodiments be located with, for example, the memory 342 or another memory.

The system bus 110 can serve as the main electronic information highway interconnecting the other illustrated components of the hardware of data-processing system 400. In some embodiments, the processor 341 may be a CPU that functions as the central processing unit of the data-processing system 400, performing calculations and logic operations required to execute a program. Read only memory (ROM) and random access memory (RAM) of the ROM/RAM 344 constitute examples of non-transitory computer-readable storage media.

The controller 343 can interface with one or more optional non-transitory computer-readable storage media to the system bus 110. These storage media may include, for example, an external or internal DVD drive, a CD ROM drive, a hard drive, flash memory, a USB drive or the like. These various drives and controllers can be optional devices. Program instructions, software or interactive modules for providing an interface and performing any querying or analysis associated with one or more data sets may be stored in, for example, ROM and/or RAM 344. Optionally, the program instructions may be stored on a tangible, non-transitory computer-readable medium such as a compact disk, a digital disk, flash memory, a memory card, a USB drive, an optical disc storage medium and/or other recording medium

As illustrated, the various components of data-processing system 400 can communicate electronically through a system bus 351 or similar architecture. The system bus 351 may be, for example, a subsystem that transfers data between, for example, computer components within data-processing system 400 or to and from other data-processing devices, components, computers, etc. The data-processing system 400 may be implemented in some embodiments as, for example, a server in a client-server based network (e.g., the Internet) or in the context of a client and a server (i.e., where aspects are practiced on the client and the server). An example of the data-processing system 400 implemented as a server is the remote server 36 shown in FIG. 2.

In some example embodiments, data-processing system 400 may be, for example, a standalone desktop computer, a laptop computer, a Smartphone, a pad computing device and so on, wherein each such device can be operably connected to and/or in communication with a client-server based network or other types of networks (e.g., cellular networks, Wi-Fi, etc). An example of a mobile device implementation of data-processing system 400 is the mobile device 34 shown in FIG. 2.

FIG. 5 illustrates a software apparatus 450 for directing the operation of the data-processing system 400 depicted in FIG. 4. The software apparatus 450 can be implemented as, for example, the software apparatus 32 shown in FIG. 2. The software application 454, may be stored for example in memory 342 and/or another memory and can include one or more modules such as the module 452. The software apparatus 450 also includes a kernel or operating system 451 and a shell or interface 453. One or more application programs, such as software application 454, may be “loaded” (i.e., transferred from, for example, mass storage or another memory location into the memory 342) for execution by the data-processing system 400. The data-processing system 400 can receive user commands and data through the interface 453; these inputs may then be acted upon by the data-processing system 400 in accordance with instructions from operating system 451 and/or software application 454. The interface 453 in some embodiments can serve to display results, whereupon a user 459 may supply additional inputs or terminate a session. The software application 454 can include module(s) 452, which can, for example, implement the steps, instructions, operations and scripts such as those discussed herein.

The following discussion is intended to provide a brief, general description of suitable computing environments in which the system and method may be implemented. Although not required, the disclosed embodiments will be described in the general context of computer-executable instructions, such as program modules, being executed by a single computer. In most instances, a “module” (also referred to as an “engine”) may constitute a software application, but can also be implemented as both software and hardware (i.e., a combination of software and hardware). Thus, for example, an NLP engine may also be referred to as an NLP module.

Generally, program modules include, but are not limited to, routines, subroutines, software applications, programs, objects, components, data structures, etc., that perform particular tasks or implement particular data types and instructions. Moreover, those skilled in the art will appreciate that the disclosed method and system may be practiced with other computer system configurations, such as, for example, hand-held devices, multi-processor systems, data networks, microprocessor-based or programmable consumer electronics, networked PCs, minicomputers, mainframe computers, servers, and the like.

Note that the term module as utilized herein can refer to a collection of routines and data structures, which can perform a particular task or can implement a particular data type. A module can be composed of two parts: an interface, which lists the constants, data types, variable, and routines that can be accessed by other modules or routines, and an implementation, which is typically private (accessible only to that module) and which includes source code that actually implements the routines in the module. The term module may also simply refer to an application, such as a computer program designed to assist in the performance of a specific task, such as word processing, accounting, inventory management, etc.

In some example embodiments, the term “module” can also refer to a modular hardware component or a component that is a combination of hardware and software. It should be appreciated that implementation and processing of the disclosed modules, whether primarily software-based and/or hardware-based or a combination thereof, according to the approach described herein can lead to improvements in processing speed and ultimately in energy savings and efficiencies in a data-processing system such as, for example, the data-processing system 400 shown in FIG. 4.

The disclosed embodiments can constitute an improvement to a computer system (e.g., such as the data-processing system 400 shown in FIG. 4) rather than simply the use of the computer system as a tool. The disclosed modules, instructions, steps and functionalities discussed herein can result in a specific improvement over prior systems, resulting in improved data-processing systems.

FIG. 4 and FIG. 5 are intended as examples and not as architectural limitations of disclosed embodiments. Additionally, such embodiments are not limited to any particular application or computing or data processing environment. Instead, those skilled in the art will appreciate that the disclosed approach may be advantageously applied to a variety of systems and application software. Moreover, the disclosed embodiments can be embodied on a variety of different computing platforms, including Macintosh, UNIX, LINUX, and the like.

It is understood that the specific order or hierarchy of steps, operations, or instructions in the processes or methods disclosed is an illustration of exemplary approaches. For example, the various steps, operations or instructions discussed herein can be performed in a different order. Similarly, the various steps and operations of the disclosed example pseudo-code discussed herein can be varied and processed in a different order. Based upon design preferences, it is understood that the specific order or hierarchy of such steps, operation or instructions in the processes or methods discussed and illustrated herein may be rearranged. The accompanying claims, for example, present elements of the various steps, operations or instructions in a sample order, and are not meant to be limited to the specific order or hierarchy presented.

The inventors have realized a non-abstract technical solution to the technical problem to improve a computer-technology by improving efficiencies in such computer technology. The disclosed embodiments offer technical improvements to a computer-technology such as a data-processing system, and further provide for a non-abstract improvement to a computer technology via a technical solution to the technical problem(s) identified in the background section of this disclosure. The disclosed embodiments require less time for processing and also fewer resources in terms of memory and processing power in the underlying computer technology. Such improvements can result from implementations of the disclosed embodiments. The claimed solution may be rooted in computer technology in order to overcome a problem specifically arising in the realm of computers and computer networks.

It will be appreciated that variations of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the following claims.

What is claimed is:

1. A method for data wrangling, comprising:
issuing a data-wrangling command with respect to a raw data source comprising unstructured data, in response to an input by a user;
translating the data-wrangling command into an executable data wrangling task with respect to the raw data source; and
autonomously performing the executable data wrangling task with respect to the raw data source after translating the data-wrangling command into the executable data wrangling task.

2. The method of claim 1 wherein the data-wrangling command is translated into the executable data wrangling task by a natural language process engine accessible as at least one of: an application programming interface or a web service.

3. The method of claim 1 wherein the executable data wrangling task with respect to the raw data source involves:
gathering relevant unstructured data from the unstructured data in the raw data source from at least one of: a remote server, a computer file system associated with the user, an application programming interface, a web service, or a mobile device; and
sending relevant processed unstructured data to at least one of: the remote server, the computer file system associated with the user, the application programming interface, the web service, or the mobile device.

4. The method of claim 1 wherein the data-wrangling command comprises at least one of: a voice command or a text command.

5. The method of claim 4 wherein the voice command or the text command comprises a data-wrangling command involving at least one of the following types of data-wrangling commands:
a command to merge file records with respect to the unstructured data;
a command to perform qualitative data categorization with respect to the unstructured data;
a command to perform quantitative data categorization with respect to the unstructured data;
a command to perform mathematical functions with respect to the unstructured data;
a command to perform data sorting with respect to the unstructured data;
a command to perform data grouping with respect to the unstructured data;
a command to send processed data to a specified location after execution of a data wrangling task;
a command to perform data comparison with respect to the unstructured data or;
a command to perform data formatting with respect to the unstructured data.

6. The method of claim 1 wherein the executable data wrangling task comprises an Extract Transform and Load (ETL) functionality executed autonomously.

7. The method of claim 1 wherein the executable data wrangling task comprises a process of transforming and mapping data from one form into another to render the data more appropriate and valuable for a plurality of downstream purposes than the unstructured data.

8. A system for data wrangling, comprising:
at least one processor; and
a non-transitory computer-usable medium embodying computer program code, the computer-usable medium operable to communicate with the at least one processor, the computer program code comprising instructions executable by the at least one processor and configured for:
issuing a data-wrangling command with respect to a raw data source comprising unstructured data, in response to an input by a user;
translating the data-wrangling command into an executable data wrangling task with respect to the raw data source; and
autonomously performing the executable data wrangling task with respect to the raw data source after translating the data-wrangling command into the executable data wrangling task.

9. The system of claim 8 wherein the data-wrangling command is translated into the executable data wrangling task by a natural language process engine accessible as at least one of: an application programming interface or a web service.

10. The system of claim 8 wherein the instructions for translating the data-wrangling command into the executable data wrangling task with respect to the raw data source, further comprises instructions configured for:
gathering relevant unstructured data from the unstructured data in the raw data source from at least one of: a remote server, a computer file system associated with the user, an application programming interface, a web service, or a mobile device; and
sending relevant processed unstructured data to at least one of: the remote server, the computer file system associated with the user, the application programming interface, the web service, or the mobile device.

11. The system of claim 8 wherein the data-wrangling command comprises at least one of: a voice command or a text command.

12. The system of claim 11 wherein the voice command or the text command comprises a data-wrangling command involving at least one of the following types of data-wrangling commands:
a command to merge file records with respect to the unstructured data;
a command to perform qualitative data categorization with respect to the unstructured data;
a command to perform quantitative data categorization with respect to the unstructured data;
a command to perform mathematical functions with respect to the unstructured data;
a command to perform data sorting with respect to the unstructured data;
a command to perform data grouping with respect to the unstructured data;
a command to send processed data to a specified location after execution of a data wrangling task;
a command to perform data comparison with respect to the unstructured data or;
a command to perform data formatting with respect to the unstructured data.

13. The system of claim 8 wherein the executable data wrangling task comprises an Extract Transform and Load (ETL) functionality executed autonomously.

14. The system of claim 8 wherein the executable data wrangling task comprises a process of transforming and mapping data from one form into another to render the data more appropriate and valuable for a plurality of downstream purposes than the unstructured data.

15. A non-transitory computer-readable media including instructions which when executed by the one or more processors, cause the one or more processors to perform data wrangling operations including:
issuing a data-wrangling command with respect to a raw data source comprising unstructured data, in response to an input by a user;
translating the data-wrangling command into an executable data wrangling task with respect to the raw data source; and
autonomously performing the executable data wrangling task with respect to the raw data source after translating the data-wrangling command into the executable data wrangling task.

16. The non-transitory computer-readable media of claim 15 wherein the data-wrangling command is translated into the executable data wrangling task by a natural language process engine accessible as at least one of: an application programming interface or a web service.

17. The non-transitory computer-readable media of claim 15 wherein the wherein the executable data wrangling task with respect to the raw data source involves:
gathering relevant unstructured data from the unstructured data in the raw data source from at least one of: a remote server, a computer file system associated with the user, an application programming interface, a web service, or a mobile device; and
sending relevant processed unstructured data to at least one of: the remote server, the computer file system associated with the user, the application programming interface, the web service, or the mobile device.

18. The non-transitory computer-readable media of claim 15 wherein the data-wrangling command comprises at least one of: a voice command or a text command.

19. The non-transitory computer-readable media of claim 18 wherein the voice command or the text command comprises a data-wrangling command involving at least one of the following types of data-wrangling commands:
a command to merge file records with respect to the unstructured data;
a command to perform qualitative data categorization with respect to the unstructured data;
a command to perform quantitative data categorization with respect to the unstructured data;
a command to perform mathematical functions with respect to the unstructured data;
a command to perform data sorting with respect to the unstructured data;
a command to perform data grouping with respect to the unstructured data;
a command to send processed data to a specified location after execution of a data wrangling task;
a command to perform data comparison with respect to the unstructured data or;
a command to perform data formatting with respect to the unstructured data.

20. The non-transitory computer-readable media of claim 15 wherein the executable data wrangling task comprises an Extract Transform and Load (ETL) functionality executed autonomously.
